(19) United States
(12) Patent Application Publication
(10) Pub. No.: US 2008/0089240 A1
(43) Pub. Date: Apr. 17, 2008

(54) Network Analysis Tool

(75) Inventors: Fergal Toomey, Dublin (IE); Brian McGurk, Dublin (IE)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: CORVIL LIMITED, Dublin (IE)

(21) Appl. No.: 11/722,701

(22) PCT Filed: Dec. 23, 2004
(86) PCT No.: PCT/IE04/00177

§ 371 Date: Jun. 27, 2007

(30) Foreign Application Priority Data
Dec. 23, 2004 (WO) PCTIE2004000177

(51) Int. Cl. H04L 12/26

(52) U.S. Cl. 370/252

(57) ABSTRACT

A network analysis tool is provided. The tool is configured to enable the analysis of traffic on the network so as to provide for scheduler hierarchies. By analysing the traffic using techniques based on large deviation theory the present invention provides for the analysis of traffic on multiple inputs to a scheduler based on the traffic class and a parameter defining how traffic on that specific input should be treated.

### FIELD OF THE INVENTION

Embodiments of the present invention relate to network analysis tools and more particularly to network analysis tools configured for providing an analysis of different classes of network traffic being served at multiple inputs to a scheduler in a network and for use in scheduler hierarchies.

### BACKGROUND

A communication network is a collection of network elements interconnected so as to support the transfer of information from a user at one network node to a user at another. The principal network elements are links and switches. A link transfers a stream of bits from one end to another at a specified rate with a given bit error rate and a fixed propagation time. The rate at which a buffer is served is the service capacity, measured in bits per second. Other common terms for service capacity are link-rate and bandwidth. Important links are:
optical fibre;
copper coaxial cable;
microwave wireless.

Several incoming and outgoing links meet at a switch, a device that transfers bits from its incoming links to its outgoing links. The name “switch” is used in telephony, while in computer communications, the device that performs routing is called a router; the terms are used interchangeably in this specification. When the rate of incoming bits exceeds that of outgoing bits, the excess bits are queued in a buffer at the switch. The receiver of each incoming link writes a packet of bits into its input buffer; the transmitter of each outgoing link reads from its output buffer. The switch transports packets from an input buffer to the appropriate output buffer. An schematic example of such a network arrangement is shown in FIG. 1 where a router 100 including an input buffer 110 and an output buffer 120 is used to couple one or more incoming links 130 with one or more outgoing links 140. When a queue is implemented in the buffer it is not always desirable that the queue should be served in a first in first out (FIFO) manner, as it is possible that the information or data being transported on specific inputs is more important than that on other inputs and therefore needs to be served quicker. As such a hierarchical structure is required.

The quality of a communications network service, as perceived by a user, varies greatly with the state of the network. To make packet-switched networks economically viable, it is necessary to be able to guarantee quality while reducing capital investment and operating expenses.

Degradation in the perceived quality of a service can often be traced back to loss or delay of data packets at a node or switch in the network. User satisfaction can be guaranteed by managing loss and delay of packets at those nodes where congestion can occur.

Typically, users transmit bits in bursts: active periods are interspersed with periods of inactivity. The peak rate of transmission cannot exceed the link rate. The mean rate of transmission, by definition, cannot exceed the peak rate. The ratio:

$$\frac{( peak rate ) - ( mean rate )}{( mean rate )}$$

is a measure of what is called the burstiness of the source.

Loss and delay of data packets at a node in the network arise from the queuing of packets in the buffers of switches or routers. Buffers are required to cope with fluctuations in the bit-rate on incoming links. However, if the buffers are too small, packets will be lost as a result of buffer overflow; if the buffers are too large, some packets will experience unacceptable delays. For a given buffer-size, loss and delay can be reduced by increasing the capacity of the outgoing link.

To eliminate packet loss entirely, it would be necessary to increase the capacity of the outgoing link to equal the sum of the capacities of the incoming links. This is prohibitively expensive. Nevertheless, it is a strategy employed sometimes by network operators who take a conservative view on assuring network quality of service.

Another known technique is based on an understanding that it is unnecessary to eliminate packet loss and unacceptable packet delay in order to give satisfactory perceived quality. It is enough to keep their frequency within predetermined bounds. These bounds are referred to as Quality of Service (QoS) targets. The term Quality of Service (QoS) is used to describe the level of packet loss, packet delay and variation in delay experienced when traffic crosses a network.

The optimal way to ensure satisfactory perceived quality is to provide the minimum capacity that will guarantee the QoS targets. This minimum capacity is referred to as the Bandwidth Requirement (BWR) of the bit-stream. It lies somewhere between mean rate and the peak-rate requirement.

Modern internet protocol (IP) networks are used by many different applications and each one requires a different level of service from the network. Some transmit small volumes of data but depend critically on the variation in time for individual packets to transit the network; some require timely transmission of large volumes of data but are insensitive to the variation in delay experienced by individual packets. The wide variety of applications carried by a network can be grouped into broad categories according to their QoS requirements. For example, a real-time category might contain applications such as “Voice over IP” or “video conferencing” which require tight control on the delay experienced by their traffic.

The QoS obtained by a particular application's traffic is determined by the route the traffic takes across the network and the amount of queuing that is encountered at each of the routers along that path. The more service that is available on the link between a pair of routers, the smaller the queues will be at those routers. Each link is likely to be shared by the traffic from many different applications. If all this traffic is queued together, it will all experience similar QoS. The first step in obtaining differing levels of QoS for different applications is sorting the traffic into classes based on its QoS requirements. The traffic from each class can then be queued separately, allowing different QoS for each.

Having classified the traffic into different queues, the operator can then define a scheduling policy that defines the order in which packets from the different queues will be transmitted on the link. The most common scheduling algorithms consist of two basic disciplines:

The simplest scheduling discipline is to allocate strict priority to one queue over another. In that case, if both queues have traffic awaiting transmission then all the packets from the higher priority queue will be transmitted first. We refer to such a scheduler as a Priority Scheduler.

Sometimes it is not possible or desirable to rank the service classes in strict priority. In that case, the usual alternative is to share the available service capacity between the classes in configured proportions. There are several different algorithms for doing this; examples include Weighted Fair Queuing (WFQ) or Deficit Weighted Round Robin (DWRR). In this document, we refer to these algorithms collectively as Weighted Schedulers.

These algorithms can be combined to create more complex scheduling hierarchies. For example, consider a four-queue system where one queue has high priority and the remaining service is shared between the other three queues by a WFQ scheduler.

These classification and scheduling mechanisms allow for differentiating between service classes and ensure that different classes obtain different levels of QoS. However, they do not alone solve the problem of ensuring that classes achieve their QoS targets. Classes can be arranged into a complex scheduling hierarchy with prioritisation and weighted sharing of service, but it is often still unclear whether the service-level objectives for the classes are being met. The missing piece is the relationship between the available bandwidth and the QoS received by the classes. This relationship is at the heart of the following questions:

What QoS is being achieved by each class?

For a given scheduling configuration, which classes are meeting their QoS targets?

How much bandwidth is required to achieve desired levels of QoS?

If all classes are currently meeting their targets, how much headroom is there?
   Alternatively, if some classes are not meeting their targets, what link capacity would be required to ensure they do?
   What scheduling discipline best suits the QoS policy with the available bandwidth?

Existing approaches to this problem include:

applying heuristic “rules of thumb” or general manufacturer's guidelines; adjusting a default configuration to the demands of a specific site by trial-and-error based on the quality received;

calculating the bandwidth needs of each class from models of the traffic (e.g. multiplying the bit-rate of a single VoIP call by the average number of calls in progress);

testing configurations with synthetic traffic generators before using them in a live network.

These techniques do not respond to changes in the traffic, or at best respond slowly. The latter two require modelling of the network traffic which has a very complex structure not easily captured by statistical models. The first technique is time-consuming, requires detailed measurements of the QoS being received and can not be used to examine the effect of changes in configuration without first making the changes.

One statistical attempt which is based on a single class of traffic is known from U.S. Pat. Specification No. 6,580,691 (Bjoerkman et al) which provides an estimation of the band width requirement (BWR) by making certain statistical assumptions about the traffic flow. The method described provides a polygonal approximation to a scaled cumulant generating function (sCGF). This US Patent Specification discloses a method and system for estimating the sCGF on-line in real time and using it to estimate the BWR. The statistical assumptions made by the sCGF method require a particular relationship between a quality target (such as a packet delay) and the frequency with which that target is exceeded. This relationship is exploited in the production of a compact traffic descriptor. This method suffers in that it is limited to a single class and therefore cannot be applied to the normal IP networks of today where multiple classes are carried on a single network and their flow through the network needs to be scheduled appropriately.

### SUMMARY

A first embodiment of the invention may use a scaled cumulant generating function (sCGF) to capture the relevant statistical properties of the traffic. Embodiments of this invention may provide a method of calculating a sCGF that describes the statistical service available to a class by combining the sCGFs of the traffic on the other classes in a manner that reflects the detailed scheduling configuration. The quality being achieved at each class can then be determined from the CGFs of its traffic and its available service.

Embodiments of the invention also provide a network analysis tool according to claim 1 with advantageous embodiments provided in the dependent claims thereto. A network architecture according to claim 11 may also be provided. Furthermore in accordance with the teaching of embodiments of the present invention a bandwidth analyser according to claim 12 may also be provided. A scheduler optimiser in accordance with the teaching of claim 13 may also be provided. Embodiments of the invention may further teach a method of analysing different classes of network traffic being served at multiple inputs to a node in the network in accordance with the operations of claim 14.

### BRIEF DESCRIPTION OF THE DRAWINGS

Exemplary embodiments of the present invention will now be described with reference to the accompanying drawings in which:

FIG. 1 is an example of a known router configuration, in accordance with various embodiments.

FIG. 2 is shows a hierarchical structure exemplary of the type of router configuration that may be analysed using a tool in accordance with embodiments of the present invention.

FIG. 3 is an example of the components that may be used in the analysis of the traffic classes at multiple inputs to the router of FIG. 2, in accordance with various embodiments.

### DETAILED DESCRIPTION OF THE DRAWINGS

Embodiments of the present invention will now be described with reference to the following drawings.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

Within an IP network traffic can be classified according to its nature or class. As mentioned above in the Background to the Invention, classes may include Voice over IP (VoIP), data traffic and the like. Embodiments of the present invention may provide for a capture of the statistical nature of the service available to each class in a scheduling hierarchy. Using an approach based on large deviation theory, the statistical characteristics of traffic and service that are relevant to the queueing properties of the traffic can be summarised by mathematical functions called scaled Cumulant Generating Functions (sCGF's). The sCGF may describe the statistics of a random process. If we view the traffic arriving at a queue as a random process and denote the cumulative volume arriving at the queue as a function of time by A(t) (i.e. the Arrivals Process), then the sCGF of the traffic λ_{A}(θ) may be given by,

$${λ}_{A} ( θ ) = {lim}_{t -> ∞} \frac{1}{t} log E {ⅇ}^{θ A ( t )} . \qquad ( 1 )$$

As will be known from a review of U.S. Pat. No. 6,580,691 (the contents of which are incorporated herein by way of reference), it is known to use the sCGF to analyse the queuing properties of traffic being served at a constant rate. The key to the analysis is the calculation from the traffic's CGF and the constant service rate of an asymptotic decay rate for the queue-length distribution. It is possible to extend this analysis to the case where the service rate is not constant but instead varies stochastically; for example, see “Large Deviations and overflow probabilities for the general single server queue, with Applications” Duffield and O'Connell, Mathematical Proceedings of the Cambridge Philosophical Society, 118 (1995) 363-374).

Just as the traffic can be described by a sCGF, so too can the service available to the queue. In a similar fashion to how the sCGF of the traffic can be given by Equation 1, for a random process S, the sCGF (λ_{S}(θ)) of the service may be determined from Equation 2 below,

$${λ}_{S} ( θ ) = {lim}_{t -> ∞} \frac{1}{t} log E {ⅇ}^{θ S ( t )} . \qquad ( 2 )$$

where the cumulative available service is denoted by S(t).

The sCGF of the service available to a class may depend on the total service available at the link, the details of the scheduling policy and the sCGFs of the other classes in the hierarchy. Heretofore, it was not possible to take the possibility and effect of the contribution of different classes into account. Embodiments of this invention may provide a method of calculating the service sCGF for each class in scheduling hierarchy. The calculation may be done in a modular fashion that mirrors the structure of the hierarchy. Firstly, a service sCGF may be constructed to represent the total capacity available at the link. For the first scheduler in the hierarchy, this may be used to calculate a service sCGF for each of the inputs. In turn, these sCGFs may be used as the input to schedulers further up the hierarchy.

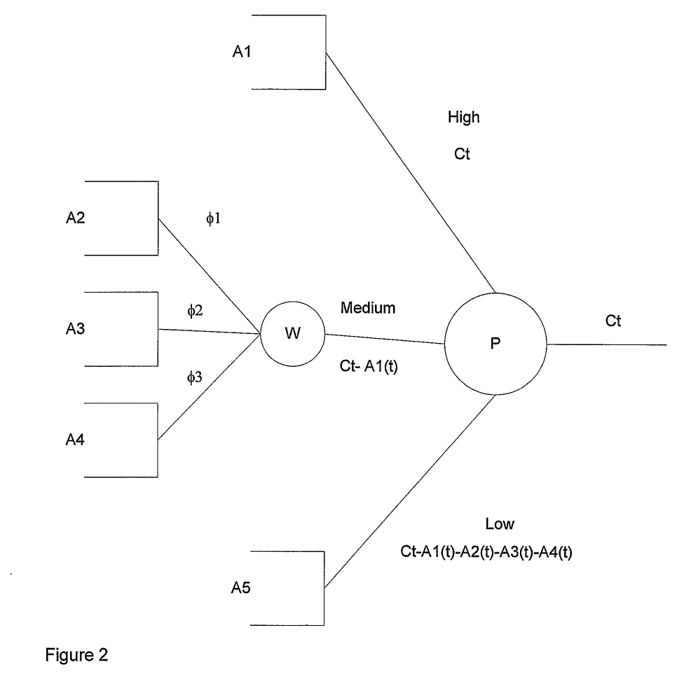

For example, consider the scheduling hierarchy shown in FIG. 2. The hierarchy of objects represents three classes (A2, A3, A4) which may share service at a weighted scheduler (W) which in turn may share service with two other classes (A1, A5) at a priority scheduler, P. The priority scheduler, P, may share the service capacity of the link between A1, A5 and the output of the weighted scheduler W, according to the individual priorities of each of the links to the scheduler P. In this example of a priority scheduler, the inputs to the priority scheduler may be ranked from High to Medium to Low, with the High priority meaning that the inputs on that link are prioritised. Based on the sCGF of A1 and the link rate, it may be possible to calculate the SCGF of the varying portion of the link capacity available for the weighted scheduler to share between the remaining classes. The inputs to the weighted scheduler may be weighted φ1, φ2, φ3. The weighted scheduler may then calculate, based on this sCGF and the sCGF's of the classes at its inputs, the sCGF's to describe the service available to A2, A3 and A4. The remaining available service rate may then be available for allocation to A5.

The service sCGF for the input to a scheduler may depend on the traffic sCGFs at the other inputs and the sCGF describing the service available to the scheduler as a whole. The calculation of an input's service sCGF may also depend on the scheduler type, and certain assumptions can be made:

Priority. For any input to a Priority scheduler, the traffic may be transmitted using the excess service after all the waiting traffic of higher priority has been served. So the service available to any input may be that available to the scheduler minus that taken up by higher priority inputs.

Weighted. The service sCGF for an input may be modelled as the sum of two parts:

1) a share of the scheduler's service sCGF proportional to the class's weight

2) low-priority access to the remainder of the scheduler's service. This is a simplified assumption which captures most of the sharing of service between classes.

Finally, if the service sCGF (λ_{S}) and the sCGF of the traffic arriving at a queue, λ_{A}, are both known, then it can be determined whether the traffic arriving at the queue will achieve its quality targets. QoS targets for a queue may consist of a tolerated level of packet loss (due to buffer overflow) pₗ, together with a delay bound D and an associated tolerated level of delay violation p_{d}. In other words, in a queue that is meeting such a target, the fraction of packets dropped will be less than pₗ and the fraction delayed by more than D seconds will be less than p_{d}. It will therefore be appreciated that the QoS can be determined in respect of either a delay constraint or a loss constraint—ie how long a particular packet is delayed at a point in the network or how many packets are lost respectively.

The delay constraint will be met if

$$sup \{ {λ}_{A} ( θ ) : {λ}_{A} ( θ ) + {λ}_{S} ( - θ ) \leq 0 \} \leq \frac{- log {p}_{d}}{D} . \qquad ( 3 )$$

With regard to the determination of whether a loss constraint is being met by the available stochastic service, one technique in accordance with embodiments of the invention may be to convert it into an equivalent delay constraint. In order to convert the loss constraint it may be necessary to obtain a second sCGF which further characterises the traffic in the class. This second sCGF may be called the packet-arrivals CGF and may be defined by the equation:

$${λ}_{N} ( θ ) = {lim}_{t -> ∞} \frac{1}{t} log E {ⅇ}^{θ N ( t )} . \qquad ( Equation 4 )$$

where N(t) may denote the cumulative number of packets seen in t seconds. In conjunction with the arrivals or input sCGF, the packet-arrivals sCGF may characterise the packet-size distribution and can be used to derive a delay constraint that is equivalent to a specified loss-constraint by techniques such as those described in “Logarithmic asymptotics for unserved messages at a FIFO” Duffy and O'Sullivan, Markov Processes and Related Fields, 10 (1), 175-189, 2004. If the traffic meets this delay constraint in the multi-class system with stochastic service (as determined by equation 3) then the loss constraint may be met.

With regard to the calculation or estimation of service sCGF's, it will be appreciated that these can be subdivided into constant, priority and weighted depending on the application. A constant service rate may be defined as follows: if the service available to a class is constant at rate C, then S(t)=Ct and λ_{S}(θ)=Cθ, i.e. there may be a linear relationship between the service sCGF and the service available to the class. In a priority scheduler, the service available to any input may simply be the service available to the scheduler minus the amount of service used by higher priority inputs. Let Ω(θ) denote the service available to the scheduler and λᵢ(θ) the sCGF of input i. Assuming that the inputs are numbered according to their priority (so that input 1 has higher priority than input 2), then the sCGF of the service available to input j may be

$${λ}_{S}^{( j )} ( θ ) = {inf}_{α \geq θ} \{ Ω ( α ) + {\sum }_{i > j} {λ}_{A}^{( i )} ( - α ) \} . \qquad Equation 5$$

A weighted scheduler may be modelled by firstly allocating each input its configured share of the service; then each input may be additionally considered to have low-priority access to the remainder of the service, where the other inputs share high priority access. To be more concrete, if the input's weight is φ, then using the same notation as above we get that the sCGF for the service available to input j as

$${λ}_{S}^{( j )} ( θ ) = {inf}_{α \geq θ} \{ Ω ( ϕ θ + ( 1 - ϕ ) α ) + {\sum }_{i \neq j} {λ}_{A}^{( i )} ( - α ) \} .$$

Equation 6

It may be possible to determine for each class, based on the service sCGF and traffic sCGF, whether specified QoS targets will be met. The bandwidth required at the link to satisfy the QoS demands of all classes can be determined by repeating the above procedure with various different values for the total service capacity until the minimum is found that allows the targets to be met at every class. Similarly, different scheduling hierarchies can be tested to find out if it is possible to meet the demands of all classes by adjusting the weights or prioritising classes differently.

It will be understood that the methodology of embodiments of the present invention heretofore described may require the calculation of a sCGF for the traffic at the router. One technique for such calculation of a sCGF is described in detail in U.S. Pat. No. 6,580,691 and may be readily apparent to the person skilled in the art on a review of this disclosure.

Another possibility is to select a statistical model for the traffic in a class and to calculate the sCGF from the mathematical expression. For instance, some particular traffic class may consist of very regular traffic which arrives at a constant rate R; in that case, the sCGF of the traffic may be simply given by the expression Rθ, in a manner similar to that described with reference above to the estimation of service rate sCGF for a constant service rate. More generally, if the statistical behaviour of the traffic closely approximates a mathematical model (e.g. the Poisson process) then the corresponding sCGF can be calculated for the model in accordance with known mathematical techniques. It will be appreciated that each of these techniques may have associated error parameters and that these errors can be compensated for or ignored depending on the degree of accuracy required for the specific measurement.

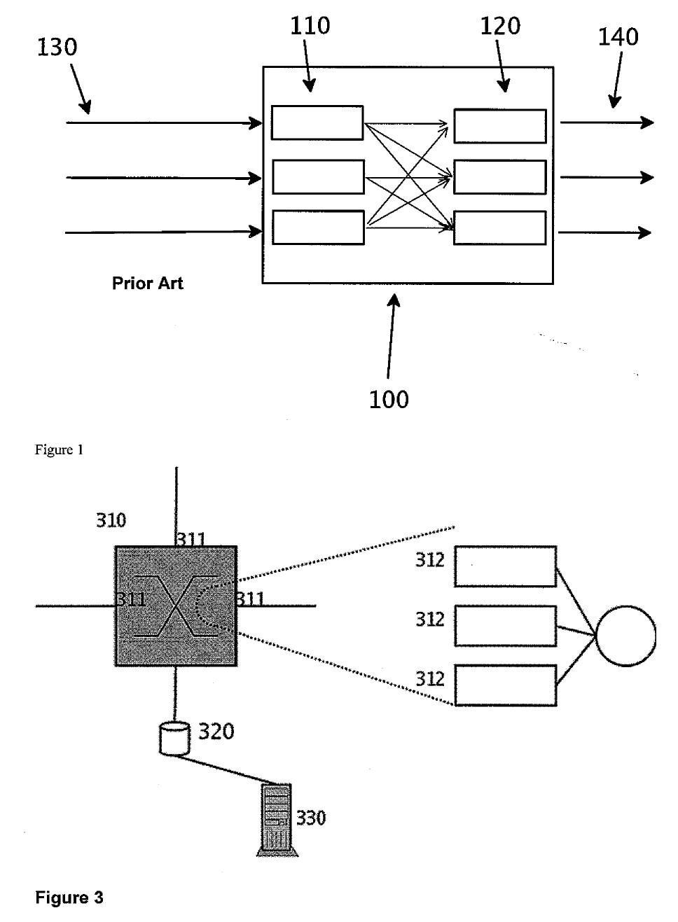

FIG. 3 shows an example of an architecture useful in the implementation of embodiments of the present invention. A router 310 similar to that shown in FIG. 1 may be provided as a node in a packet network infrastructure. The router may be configured to route traffic arriving on multiple inputs or interfaces 311 to the router to specific locations within the network in accordance with the standard operation of such routers. The router may be coupled to a database 320, which may be accessible by a workstation 330. As part of the configuration of the router, information may be defined or provided relating to the total service available at that router. The router may be further instrumented or configured to provide volume and packet counters 312 at any of the interfaces and for any classes defined at those interfaces. These low-level counters may be used to calculate the arrivals sCGF for each class on the router and are one example of a traffic analyser configured to determine the input sCGF for each of the multiple inputs to the router. The input sCGFs may be stored in the database 305 and used by the processor of the workstation, together with the details of the router configuration to analyse the QoS available to each class on the router. The workstation may achieve this analysis by having a service module defined thereon and configured to output a service sCGF for each of the inputs to the router, the sCGF for each of the selected inputs being related to the input sCGF's available at the router and the total service available. Such service sCGF's may represent how the class of traffic at that selected input to the router is being served so as to provide an analysis parameter of different classes of network traffic and can be used to then analyse the QoS available. If a less comprehensive analysis is sufficient, the workstation can be configured to select one class for specific analysis if the input CGFs are available for all classes on that share that interface. Usually, however analysis of all inputs may be conducted. The user of the workstation can then determine how much bandwidth is required to meet the QoS requirements of each class or what scheduling configuration may be optimal. It will be appreciated that although the router, database and workstation are shown here as single distinct components that they can easily be provided in multiples or indeed provided as a single component with all three features embedded thereon, i.e. a router with integrated processor and database can be provided thereby providing a single network analysis tool.

It will be appreciated that embodiments of the present invention may provide for a number of benefits including:

Real-time reporting of the QoS being achieved by traffic passing through a router or the bandwidth required at the link to achieve specified QoS levels. Such reporting may be advantageous for a number of reasons including the capability to modify the bandwidth available to specific applications dependent on criteria being met;

Off-line planning: for instance, determining in advance the effect of changing a scheduling discipline or introducing multi-class queuing or the benefits of a link upgrade;

Extensible distributed algorithm enables support for arbitrary combinations of the supported scheduler types. Supporting additional scheduler types may simply involve determining how the service CGF is transformed by the scheduler.

The embodiments of the present invention are advantageous in that they provide for a real-time update on the traffic as it is passing through the network as opposed to the traditional approach, which has tended to rely on statistical modelling of the traffic and subsequently may be unresponsive to changes in the traffic.

It will be further understood that the methodology of embodiments of the present invention, being based on large deviation theory may make certain assumptions relating to size of the buffer systems being analysed. If the system being analysed does not conform to these ideal criteria then modifications may be made to avoid inaccuracies. For example, if the delay constraints are relatively small then it may be necessary to account for the effects of serialisation delay; this can be done by adjusting the delay constraint target.

As will be apparent to the person skilled in the art, embodiments of the present invention may provide for an analysis of the network traffic based on measurements of the traffic and calculations based on those measurements. The tool and methodology of embodiments of the present invention may be implemented in hardware and/or software configurations. For example, the provision of the counters necessary to provide for the counting of the volume and/or packets being routed through the schedulers may be provided in analog or digital electronics or for example as a software module adapted to cooperate with one or more microprocessors.

The words comprises/comprising when used in this specification are to specify the presence of stated features, integers, operations or components but does not preclude the presence or addition of one or more other features, integers, operations, components or groups thereof.

1. A network analysis tool configured for providing an analysis of multiple classes of network traffic being served at a scheduler in a router provided in the network, each of the classes being provided at distinct inputs to the scheduler, the tool including:
a) a determiner for determining the total service available to that scheduler,
b) a traffic analyser configured to determine an input scaled cumulant generating function (sCGF) for each of the multiple classes,
c) a selector for selecting at least one of the multiple classes for analysis of the traffic on that input, and
d) a service module configured to output a service sCGF for each of the selected inputs, the sCGF for each of the selected inputs being related to the input sCGFs available at the scheduler and the total service available, the service sCGF representing how the class of traffic at that selected input to the scheduler is being served.

2. The tool as claimed in claim 1 wherein each of the multiple inputs to the scheduler has a different parameter associated therewith which describes how the scheduler allocates service to it.

3. The tool as claimed in claim 2 wherein the service module is configured to output a service sCGF for each of the inputs to the scheduler, the service sCGF for each input being related to the parameter for that input.

4. The tool as claimed in claim 2 wherein the scheduler is a priority scheduler, the parameter associated with each of the inputs being related to the priority of the traffic class being served at that input such that traffic served at a selected input is transmitted using any excess service available after all waiting traffic of a higher priority has been served.

5. The tool as claimed in claim 2 wherein the hierarchical scheduler is a weighted scheduler, the parameter associated with each of the inputs being related to the weighting of the traffic class being served at that input and wherein the service available to a selected input is proportional to the weight of the class being served at that input.

6. The tool as claimed in claim 4 wherein the priority scheduler includes as an input to the scheduler the output of a weighted scheduler, the weighted scheduler having a plurality of inputs thereto, the service available to a selected input of the weighted scheduler being a share of the service left over by inputs of higher priority proportional to the weight of that input.

7. The tool as claimed in claim 1 further including a delay evaluator, the delay evaluator configured to determine whether a defined delay constraint is met at a selected input of the multiple inputs to the node, the determination being resolved using a combination of the input sCGF at that input and the service sCGF of that input.

8. The tool as claimed in claim 7 wherein the determination is resolved on a solving of the equation:
$$sup \{ {λ}_{A} ( θ ) : {λ}_{A} ( θ ) + {λ}_{S} ( - θ ) \leq 0 \} \leq \frac{- log {p}_{d}}{D} .$$
where λ_{A}(θ) is the input sCGF of the arrivals process at that input to the node, λ_{S}(θ) is the service sCGF at that input, p_{d} is the associated tolerated level of delay violation and D is the delay bound.

9. The tool as claimed in claim 7 further including a loss evaluator, the loss evaluator configured to determine whether a defined loss constraint is met at a selected input of the multiple inputs to the node, the loss evaluator using a calculated delay constraint to determine if a particular loss constraint value is met.

10. The tool as claimed in claim 9 wherein a loss evaluator utilises a packet-arrivals sCGF, as defined by the equation:
$${λ}_{N} ( θ ) = {lim}_{t -> ∞} \frac{1}{t} log E {ⅇ}^{θ N ( t )} .$$
where N(t) denotes the cumulative number of packets seen in t seconds, in conjunction with the input sCGF to calculate an ideal delay constraint and wherein the tool is further configured to compare the ideal delay constraint with the calculated delay constraint to determine if the loss constraint is met.

11. A packet based network architecture incorporating a tool configured for providing an analysis of multiple classes of network traffic being served at a scheduler in a router provided in the network, each of the classes being provided at distinct inputs to the scheduler, the tool including:
a) a determiner for determining the total service available to that scheduler,
b) a traffic analyser configured to determine an input scaled cumulant generating function (SCGF) for each of the multiple classes,
c) a selector for selecting at least one of the multiple classes for analysis of the traffic on that input, and
d) a service module configured to output a service sCGF for each of the selected inputs, the sCGF for each of the selected inputs being related to the input sCGFs available at the scheduler and the total service available, the service sCGF representing how the class of traffic at that selected input to the scheduler is being served.

12. A bandwidth evaluator configured to determine whether a defined Quality of Service (QoS) is being met within a packet based network, the evaluator including a tool configured for providing an analysis of multiple classes of network traffic being served at a scheduler in a router provided in the network, each of the classes being provided at distinct inputs to the scheduler, the tool including:
a) a determiner for determining the total service available to that scheduler,
b) a traffic analyser configured to determine an input scaled cumulant generating function (sCGF) for each of the multiple classes,
c) a selector for selecting at least one of the multiple classes for analysis of the traffic on that input, and
d) a service module configured to output a service sCGF for each of the selected inputs, the sCGF for each of the selected inputs being related to the input sCGFs available at the scheduler and the total service available, the service sCGF representing how the class of traffic at that selected input to the scheduler is being served, the tool providing an analysis of how different classes of network traffic are served at a scheduler, the bandwidth evaluator being configured to compare how the classes are being served with a desired level of service at that scheduler, the comparison indicating whether the defined QoS is being met, the evaluator being further configured to modify the bandwidth provided at the scheduler until the QoS is met.

13. A scheduler optimiser configured to optimise how different classes of network traffic are being served at a scheduler, the optimiser including a tool configured for providing an analysis of multiple classes of network traffic being served at a scheduler in a router provided in the network each of the classes being provided at distinct inputs to the scheduler the too including:
a) a determiner for determining the total service available to that scheduler,
b) a traffic analyser configured to determine an input scaled cumulant generating function (sCGF) for each of the multiple classes,
c) a selector for selecting at least one of the multiple classes for analysis of the traffic on that input, and
d) a service module configured to output a service sCGF for each of the selected inputs the sCGF for each of the selected inputs being related to the input sCGFs available at the scheduler and the total service available, the service SCGF representing how the class of traffic at that selected input to the scheduler is being served, the tool providing an analysis of how different classes of network traffic are served at a scheduler, the optimiser being configured to modify the parameters of the inputs to the scheduler until a desired quality of service is met at the scheduler.

14. A method of analysing different classes of network traffic being served at multiple inputs to a node in the network, each of the classes being provided at distinct inputs to the node, the method including:
a) determining the total service available at that node,
b) determining an input scaled cumulant generating function (sCGF) for each of the multiple inputs to the node,
c) selecting at least one of the multiple inputs for analysis of the traffic on that input, and
d) using the input sCGFs for each of the inputs to the node and the total service available at the node to output a service sCGF for each of the selected inputs, the service sCGF representing how the class of traffic at that selected input to the node is being served.

15. The method as claimed in claim 14 further including associating a different parameter specific to each input to the node with each input to the node so as to provide a hierarchical scheduler.

16. The method as claimed in claim 15 further including the outputting a service sCGF for each of the inputs to the hierarchical scheduler, the service sCGF for each input being related to the parameter for that input.

17. The method as claimed in claim 15 wherein associating a parameter specific to each input provides for the ranking of each input relative to each other input so as to provide for a priority scheduler, the ranking of each input being related to the priority of the traffic class being served at that input such that traffic served at a selected input is transmitted using any excess service available after all waiting traffic of a higher priority has been served.

18. The tool as claimed in claim 15 wherein associating a parameter specific to each input provides for the association of a weighting of the traffic class being served at that input with that input and wherein the service available to a selected input is proportional to the weight of the class being served at that input.

19. The method as claimed in any of claim 15 further including evaluating a delay parameter, the evaluation of the delay parameter determining whether a defined delay constraint is met at a selected input of the multiple inputs to the node, the determination being resolved using a combination of the input sCGF at that input and the service sCGF of that input.

20. The method as claim in claim 19 wherein the determination is resolved on a solving of the equation:
$$sup \{ {λ}_{A} ( θ ) : {λ}_{A} ( θ ) + {λ}_{S} ( - θ ) \leq 0 \} \leq \frac{- log {p}_{d}}{D} .$$
where λ_{A}(θ) is the input sCGF of the arrivals process at that input to the node, ζ_{S}(θ) is the service sCGF at that input, p_{d} is the associated tolerated level of delay violation and D is the delay bound.

21. The method as claim in claim 19 further including evaluating a loss parameter, the evaluation of the loss parameter determining whether a defined loss constraint is met at a selected input of the multiple inputs to the node, the loss parameter evaluated using a calculated delay constraint to determine if a particular loss constraint value is met.

22. The method as claimed in claim 21 wherein the evaluating the loss parameter includes:
providing a packet sCGF, the packet sCGF being defined by:
$${λ}_{N} ( θ ) = {lim}_{t \to ∞} \frac{1}{t} log E {ⅇ}^{θ N ( t )} .$$
where N(t) represents the number of packets arriving at a scheduler over a time period t, and
using the packet sCGF in conjunction with the input sCGF to compute an an ideal delay constraint and finally comparing the ideal delay constraint with the calculated delay constraint to determine if the loss constraint is met.

23. A computer program for analysing different classes of network traffic being served at multiple inputs to a node in the network, each of the classes being provided at distinct inputs to the node, the program being adapted when run on a computer to
a) determine the total service available at that node,
b) determine an input scaled cumulant-generating function (sCGF) for each of the multiple inputs to the node,
c) select at least one of the multiple inputs for analysis of the traffic on that input and
d) use the input sCGFs for each of the inputs to the node and the total service available at the node to output a service sCGF for each of the selected inputs the service SCGF representing how the class of traffic at that selected input to the node is being served.
